(19) United States
(12) Patent Application Publication
(10) Pub. No.: US 2013/0077910 A1
(43) Pub. Date: Mar. 28, 2013

(54) HIGH SPEED MECHANICAL BEARING USING FIXED ROLLERS

(71) Applicant: Peiliang Zhang, Shrewsbury, MA (US)

(72) Inventor: Peiliang Zhang, Shrewsbury, MA (US)

(73) Assignee: SIEMENS INDUSTRY, INC., Alpharetta, GA (US)

(21) Appl. No.: 13/559,392

(22) Filed: Jul. 26, 2012

Related U.S. Application Data
(60) Provisional application No. 61/538,441, filed on Sep. 23, 2011.

(51) Int. Cl. F16C 33/46

(52) U.S. Cl. 384/572

(57) ABSTRACT

A high speed mechanical bearing for rotatably supporting the journal of a rotor comprises an annular frame defining a bore dimensioned to receive the journal, and a plurality of angularly spaced rollers carried by the frame. The rollers are arranged to project into the bore and into rotating contact with the journal.

### CROSS REFERENCE TO RELATED APPLICATION

This application claims benefit, under 35 U.S.C. §119(e), of U.S. Provisional Application Ser. No. 61/538,441, filed 23 Sep. 2011, the entire contents and substance of which is hereby incorporated by reference.

### BACKGROUND

1. Field of the Invention

Embodiments of the present invention relate generally to rolling mill laying heads, and more particularly to a high speed mechanical bearing using fixed rollers for rotatably supporting the quills of the laying heads.

2. Description of Related Art

In a conventional laying head, a stationary support structure contains a hollow quill rotatably supported between axially spaced bearings. The quill carries a curved guide pipe having an entry end aligned with the rotational axis of the quill, and a curved intermediate section projecting in a cantilever fashion from the quill to an exit end spaced radially from the quill axis. The quill is rotatably driven, with the guide pipe being configured to receive a hot rolled product at its entry end and to deliver the product as a continuous helical formation of rings emerging from its exit end.

Roller bearings are typically employed to rotatably support the quill. Under high speed operating conditions, e.g., when handling products traveling at speeds exceeding 100 m/sec, experience has shown that the roller bearings can be plagued by vibrations that disturb the operation of the laying head.

Various schemes have been devised in an attempt at eliminating or at least suppressing such vibrations. For example, as described in U.S. Pat. No. 5,590,848, the cantilevered portion of the guide pipe has been shortened in order to increase the overall stiffness of the laying head. Also, as described in U.S. Pat. No. 7,086,783, the roller bearings have been preloaded to eliminate operating clearances. Although such design modifications have been proven to be beneficial, they have not adequately addressed the vibration problems which continue to be experienced as the laying heads are operated at the ever increasing speeds of modern day rolling mills.

As described in WO2005/084842 A1, it also has been proposed to employ hydrodynamic bearings in place of roller bearings. However, under lightly loaded high speed operating conditions, as is the case with roiling mill laying heads, hydrodynamic bearings are known to experience an effect commonly referred to as “whirl”, where the rotating member orbits in a highly undesirable mode. The radius of the orbit is essentially equal to the eccentricity of the bearing tinder the specific operating conditions.

Also, hydrodynamic bearings require a higher starting torque to overcome the static friction of the rotating member. Once rotation commences, the torque requirement drops dramatically. However, the laying head motors and drive trains must be sized to deliver the higher starting torques, and this in turn increases costs.

### SUMMARY

Briefly described, aspects of the present invention relate to a high speed mechanical bearing using fixed rollers. In certain embodiments, the bearing comprises an annular frame defining a bore dimensioned to receive the journal surface of a rotor, typically the quill of a laying head. Angularly spaced rollers are carried by the frame. The rollers are arranged to project into the bore and into rotating contact with a journal surface of the rotor.

In some embodiments, the annular frame is configured to resiliently urge the rollers into contact with the journal surface. The rollers may be journalled for rotation in ball bearings which are preferably of the angular contact type.

### BRIEF DESCRIPTION OF THE DRAWINGS

FIG. 1 is a front view of a mechanical bearing notatably supporting the quill of a rolling mill laying head, in accordance with an exemplary embodiment of the present invention.

FIG. 2 is a perspective view of the mechanical bearing of FIG. 1, in accordance with an exemplary embodiment of the present invention.

FIG. 3 is a cross-sectional view of the mechanical bearing taken across line 3-3 of FIG. 1, in accordance with an exemplary embodiment of the present invention.

### DETAILED DESCRIPTION

To facilitate an understanding of embodiments, principles, and features of the present invention, they are explained hereinafter with reference to implementation in illustrative embodiments. In particular, they are described in the context of being a mechanical bearing for use in a rolling mill laying head.

Embodiments of the present invention, however, are not limited to use in the described environment.

The components and materials described hereinafter as making up the various embodiments are intended to be illustrative and not restrictive. Many suitable components and materials that would perform the same or a similar function as the materials described herein are intended to be embraced within the scope of embodiments of the present invention.

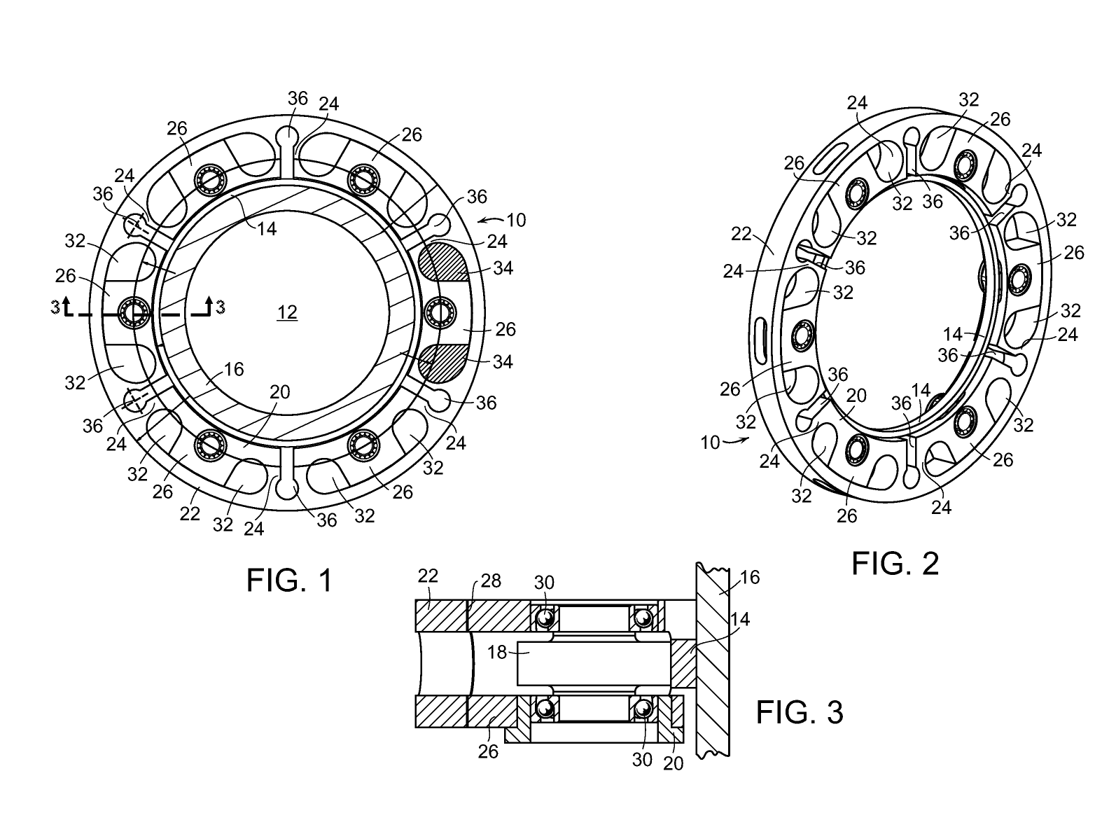

FIGS. 1-3 illustrate an exemplary embodiment of the mechanical bearing, in accordance with various aspects of the present invention. The mechanical bearing comprises an annular frame 10 defining a bore 12 dimensioned to receive the journal 14 of a rotor 16. In an exemplary embodiment, the rotor 16 may comprise the quill of a rolling mill laying head, and the journal 14 may comprise a cylindrical inner raceway configured and dimensioned to be press fitted onto the quill.

A plurality of angularly spaced rollers 18 are carried by the frame 10. The rollers 18 are arranged to project into the bore 12 and into rotating contact with the journal 16.

In a preferred aspect of the present invention, the frame 10 is configured to resiliently urge the rollers 18 into contact with the journal 16. To this end, the frame comprises inner and outer shells 20, 22 interconnected by angularly spaced struts 24. The rollers 18 are carried on ribs 26 projecting radially from the inner shell 20 and between the struts 24. As can best be seen in FIG. 3, spaces 28 may be provided between the outer ends of the ribs 26 and the outer shell 22.

The rollers 18 may be journalled for rotation in ball bearings 30. Preferably the ball bearings are angular contact ball bearings.

The struts 24 may be separated circumferentially from the ribs 26 by pockets 32. Optionally, as indicated in FIG. 1, the pockets 32 may be tilled with an elastomer 34 providing a damping effect.

Slots 36 extend radially across the inner shell 20 into the struts 24. The slotted struts 24 coact with the inner shell 20 and the radial spaces 28 between the ends of the ribs 26 and the outer shell 22 to provide the frame 10 with a built-in spring loading mechanism serving to resiliently urge the rollers 18 into contact with the journal 14 of the rotor 16.

In exemplary embodiments, the rollers 18 can be machined with high precision, with proper crowning to their cylindrical surfaces to insure that contact stresses are evenly distributed. The journal or inner raceway may also be machined with high precision.

Although the mechanical bearing of the present invention has been described with six rollers 18 angularly spaced at 60° intervals, additional or fewer rollers may be employed, depending on the characteristics of the system in which the bearing is designed to function.

While embodiments of the present invention have been disclosed in exemplary forms, it will be apparent to those skilled in the art that many modifications, additions and deletions can be made without departing from the spirit and scope of the inventor and its equivalents as set forth in the following claims.

What is claimed is:

1. A high speed mechanical bearing for rotatably supporting the journal of a rotor, said bearing comprising:
an annular frame defining a bore dimensioned to received said journal; and
a plurality of angularly spaced rollers carried by said frame, said rollers being arranged to project into said bore and into rotating contact with said journal.

2. The bearing of claim 1 wherein said frame is configured to resiliently urge said rollers into contact with said journal.

3. The bearing of claim 2 wherein said frame comprises inner and outer shells interconnected by angularly spaced radial struts, and wherein said rollers are carried on ribs projecting radially from said inner shell and between said struts.

4. The bearing of claim 3 wherein said ribs have outer ends spaced radially from said outer shell.

5. The bearing of claim 1 wherein said rollers are journalled for rotation in ball bearings.

6. The bearing of claim 3 wherein said struts are separated circumferentially from said ribs by pockets.

7. The bearing of claim 6 wherein said pockets are filled with an elastomer.

8. The bearing of claim 5 wherein said ball bearings are angular contact ball bearings.

9. The bearing of claim 1 wherein said rotor comprises the quill of a rolling mill laying head, and wherein said journal surface defines a cylindrical inner raceway configured and dimensioned to be pressed fitted onto said quill.

10. The bearing of claim 3 wherein slots extending radially across said inner shell and into said struts.

11. A high speed mechanical bearing for rotatably supporting the quill of a rolling mill laying head, said bearing comprising:
a cylindrical inner raceway internally dimensioned to be press fitted onto said quill, with the exterior of said raceway defining a journal of said quill;
a frame surrounding said raceway; and
a plurality of angularly spaced rollers carried by said frame, said frame being configured and arranged to resiliently urge said rollers radially inwardly into contact with said journal.

12. A high speed mechanical bearing for rotatably supporting the quill of a rolling mill laying head, said bearing comprising:
a cylindrical inner raceway internally dimensioned to be press fitted onto said quill, with the exterior of said raceway defining a journal of said quill;
a frame surrounding said raceway, said frame comprising inner and outer shells interconnected by angularly spaced struts, with ribs projecting radially from said inner shell and between said struts, and with the outer ends of said ribs spaced from said outer shell; and
rollers carried by said ribs, said rollers projecting radially inwardly from said inner shell into contact with said journal,

13. The bearing of claim 12 wherein said rollers are resiliently urged into contact with said journal.

14. The bearing of claim 12 wherein said rollers are journalled for rotation in ball bearings.

15. The bearings of claim 14 wherein said ball bearings are angular contact ball bearings.
